(19) United States
(12) Patent Application Publication
(10) Pub. No.: US 2026/0360957 A1
(43) Pub. Date: Nov. 12, 2026

(54) Electrolyte Fill Port Closure Plate And Termination Pin Assembly For An Electrical Power Source

(71) Applicant: Greatbatch Ltd., Clarence, NY (US)

(72) Inventors: Jordan A. Hartwig, East Aurora, NY (US); Louie Serpe, Clarence Center, NY (US); Joseph M. Prinzbach, Lancaster, NY (US)

(21) Appl. No.: 19/665,089

(22) Filed: May 1, 2026

Related U.S. Application Data
(60) Provisional application No. 63/802,704, filed on May 9, 2025.

(51) Int. Cl. H01M 50/636; H01M 4/38; H01M 4/50; H01M 4/525; H01M 4/58; H01M 4/583; H01M 50/107; H01M 50/131; H01M 50/152; H01M 50/188; H01M 50/545; H01M 50/559; H01M 50/588; H01M 4/02

(52) U.S. Cl. CPC H01M 50/636; H01M 4/382; H01M 4/502; H01M 4/525; H01M 4/5815; H01M 4/5835; H01M 50/107; H01M 50/131; H01M 50/152; H01M 50/188; H01M 50/545; H01M 50/559; H01M 50/588; H01M 2004/027; H01M 2004/028

(57) ABSTRACT

An improved terminal connection for a miniature electrical power source having a total volume that is about 0.5 cc, or smaller is described. The power source has a casing comprising an open-ended container closed by a lid. A glass-to-metal seal (GTMS) connected to the lid electrically isolates a positive polarity terminal pin from the lid and a fill port closure plate closes an electrolyte fill port. An electrode assembly comprising an anode, a cathode and an intermediate separator housed inside the casing is activated with a liquid electrolyte. The anode is connected to the casing in a case-negative design. To save space on the lid comprising the miniature power source, an upstanding negative polarity termination pin is connected to the fill port closure plate.

### CROSS-REFERENCE TO RELATED APPLICATION

This application claims priority to U.S. provisional application Ser. No. 63/802,704, filed on May 9, 2025.

### BACKGROUND OF THE INVENTION

### Field of the Invention

The present invention relates to the conversion of chemical energy to electrical energy. More particularly, the present invention relates to an improved termination structure for an end user to connect to an electrical power source that has a total size or volume that is not greater than 0.5 cc. Such so-called miniature-sized electrical power sources are defined as those having a total volume that is about 0.5 cc, or smaller.

### Prior Art

In a case-negative design, the terminal pin is electrically isolated from the negative polarity casing by a glass-to-metal seal (GTMS), and the terminal pin is connected to the cathode of an electrochemical cell or the anode of a capacitor. The GTMS is fitted in an opening in the casing lid and comprises a ferrule supporting an insulating sealing glass or insulating ceramic through which the terminal pin extends. The sealing glass or ceramic electrically isolates the terminal pin from the ferrule. The ferrule is then welded into a GTMS opening in the casing lid and, after the electrode assembly is housed in the open-ended container, the casing lid is welded to the container to close its open end to thereby provide the casing. Then, the electrode assembly is activated with an electrolyte filled into the casing through a fill port in the casing lid. The electrolyte fill port is separate from the GTMS opening and is typically hermetically sealed with a closure system comprising an inner sealing ball and an outer closure plate. Finally, as an accommodation to the end user, a negative polarity termination pin is welded to the casing lid spaced from the GTMS opening and the electrolyte fill port. In a typical power source, whether the casing has a cylindrical or prismatic shape, there is ample space for the GTMS opening, the electrolyte fill port and the negative polarity termination pin.

However, in miniature-sized electrical power sources, the casing lid is small and allocating space for the negative polarity termination pin in addition to the GTMS opening and the electrolyte fill port is challenging. Therefore, there is a need to reduce the amount of area on the casing lid that is taken by the negative polarity termination pin without making the connection to that pin overly burdensome for the end user.

### SUMMARY OF THE INVENTION

The present invention relates to an electrical power source having a casing comprising a casing lid that closes the open end of a container, preferably a cylindrically-shaped container. After an electrode assembly comprising an anode, a cathode and intermediate separator is housed inside the open-ended container, the container is closed with a casing lid welded to the container at its open end. Then, the electrode assembly is activated with an electrolyte filled into the casing through a fill port in the lid, and the electrolyte fill port is hermetically sealed with a closure system comprising an inner sealing ball and an outer closure plate.

In a preferred embodiment, the electrical power source of the present invention is a miniature-sized power source having a total volume that is about 0.5 cc, or smaller. The miniature-sized power source has a cylindrically-shaped casing comprising a cylindrically-shaped open-ended container that is closed with a circular casing lid. The casing lid has a diameter that ranges from about 0.45 inches to about 0.55 inches and includes a first GTMS opening and a second electrolyte fill port. The GTMS opening and fill port each have a circular shape with a respective diameter that ranges from about 0.045 inches to about 0.06 inches.

Fitting the GTMS opening and the fill port in a casing lid for a miniature-sized power source does not leave much extra space for connection of a negative polarity termination pin. In that respect, the power source of the present invention reduces the area needed on a closure lid for the termination pin by connecting the negative polarity termination pin to the upper surface of the closure plate for the electrolyte fill port. After the electrolyte fill port is closed with the closure plate, the closure plate serves as a connection surface for the negative polarity termination pin. This means that there is additional space on the casing lid that would have been occupied by the negative polarity terminal pin, but that can now be used for other connections that the end user may desire or that can be left unused. The negative polarity termination pin connected to the electrolyte fill port closure plate can be separate parts or they can be connected together as an assembly prior to sealing the fill port.

An exemplary primary electrochemical couple is lithium/CFₓ or lithium/silver vanadium oxide (Li/SVO). The preferred electrolyte for a Li/SVO or Li/CFₓ primary electrochemical cell is 0.8M to 1.5M LiAsF₆ or LiPF₆ dissolved in a 50:50 mixture, by volume, of PC as a preferred high permittivity solvent and DME as a preferred low viscosity solvent.

One preferred secondary chemistry for a lithium-ion electrochemical cell comprises a carbon-based or Li₄Ti₅O₁₂-based anode and a lithium metal oxide-based cathode, such as of LiCoO₂ or lithium nickel manganese cobalt oxide (LiNiₐMn_{b}Co_{1-a-b}O₂). The lithium-ion electrochemical cell is activated with a liquid electrolyte.

An exemplary capacitor couple comprises a tantalum anode and a ruthenium oxide cathode. For a capacitor, the working electrolyte has an electrical conductivity of from about 0.01 Siemens per centimeter (“S/cm”) to about 0.1 S/cm, determined at a temperature of about 25° C. using any known electric conductivity meter. The working electrolyte is generally in the form of a liquid, such as an aqueous or non-aqueous solution. For example, the electrolyte may be an aqueous solution of an acid (e.g., sulfuric acid, phosphoric acid, or nitric acid), base (e.g., potassium hydroxide), or salt (e.g., ammonium salt, such as a nitrate), as well as any other suitable electrolyte known in the art, such as a salt dissolved in an organic solvent (e.g., ammonium salt dissolved in a glycol-based solution).

These and other aspects of the present invention will become increasingly more apparent to those skilled in the art by reference to the following detailed description and to the appended drawings.

### BRIEF DESCRIPTION OF THE DRAWINGS

FIG. 1 is a perspective view, partly in cross-section, of an exemplary electrical power source 10 according to the present invention.

FIG. 2 is a cross-sectional view taken along line 2-2 of the electrical power source 10 shown in FIG. 1.

FIG. 3 is a perspective view, partly in phantom, of an exemplary cathode current collector 24 that is useful with the electrical power source 10 shown in FIGS. 1 and 2.

FIG. 3A is an enlarged view of the indicated area shown in FIG. 3.

FIG. 4 is a perspective view of a casing lid 16 for the electrical power source 10 shown in FIGS. 1 and 2 with the lid supporting a glass-to-metal seal 30 comprising a ferrule 32.

FIG. 4A is a perspective view of a casing lid 16 for the electrical power source 10 shown in FIGS. 1 and 2 with the lid supporting a glass-to-metal seal 30A that does not have a ferrule, but with the sealing glass 34 directly contacting the lid and the terminal pin 36.

FIG. 5 is a perspective view of the casing lid 16 shown in FIG. 4 with a fill port closure assembly 42 sealed in an electrolyte fill port 40 in the lid 16.

FIG. 5A is a perspective view of the fill port closure assembly 42 shown in FIG. 5 comprising a termination pin 42B connected to a fill port closure plate 42A.

FIG. 6 is a perspective view of the casing lid 16 shown in FIG. 5 with the fill port closure assembly 42 sealed in the electrolyte fill port 40 and a solder sleeve 44 supported on the termination pin 42B.

FIG. 7 is an elevational view, partly in cross-section, of another embodiment of an electrical power source 100 according to the present invention.

FIG. 8 is an elevational view of another embodiment of an electrical power source 200 according to the present invention.

### DETAILED DESCRIPTION OF THE PREFERRED EMBODIMENTS

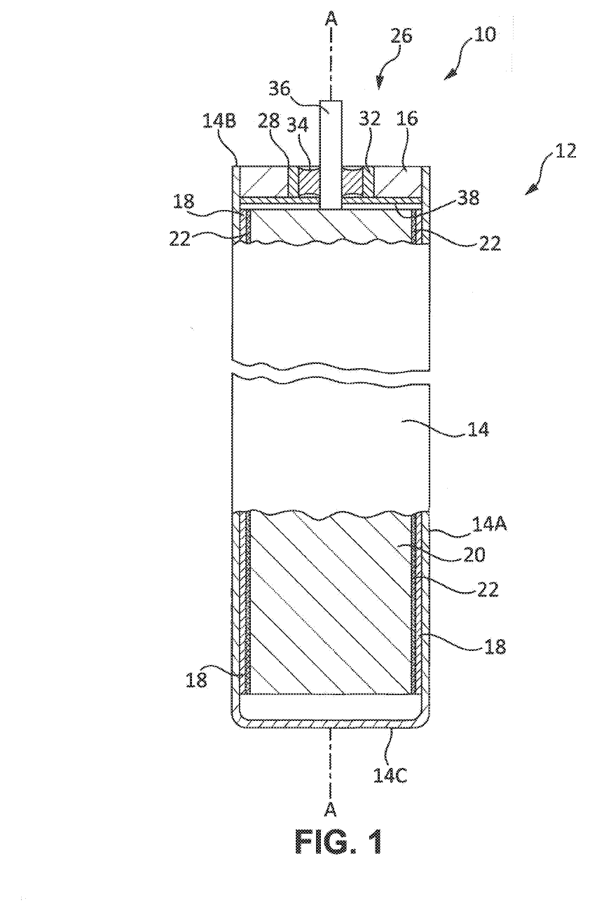

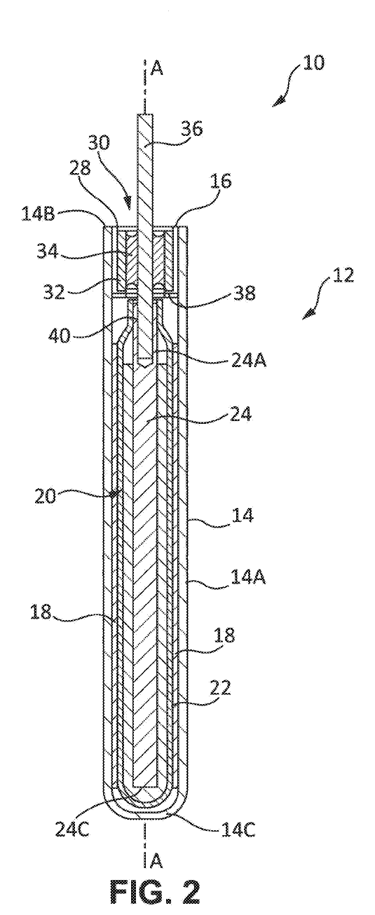

Turning now to the drawings, FIGS. 1 and 2 illustrate an exemplary electrical power source 10 according to the present invention. The electrical power source 10 can be a primary electrochemical cell, a secondary or rechargeable electrochemical cell, or a capacitor. In an exemplary embodiment, the electrical power source 10 is a so-called miniature-sized electrical power source having a total volume that is not greater than 0.5 cc.

The electrical power source 10 comprises a casing 12 formed from an open-ended container 14 closed by a plate-shaped casing lid 16. The open-ended container 14 is preferably formed in a deep-drawing process and has a cylindrically-shaped sidewall 14A extending along a longitudinal axis A-A from a proximal open end defined by a proximal circular edge or annular rim 14B to a bottom wall 14C. The cylindrically-shaped sidewall 14A has a circular shape in cross-section perpendicular to the longitudinal axis A-A and the sidewall 14A meets the bottom wall 14C at a rounded annular corner. The open-ended container 14 and casing lid 16 are made of metal, such as titanium, stainless steel, nickel, aluminum, titanium being preferred.

It is noted that deep drawing is a sheet metal forming process in which a sheet metal blank is radially drawn into a forming die by the mechanical action of a punch. It is thus a shape transformation process with material retention. The process is considered “deep” drawing when the depth of the drawn part exceeds its diameter. This is achieved by redrawing the part through a series of dies.

To construct the electrical power source 10, an electrode assembly comprising an anode 18 and a cathode 20 prevented from direct physical contact with each other by at least one intermediate separator 22 is positioned inside the container 14. The anode 18 is formed from at least one sheet of lithium that is swaged or otherwise press-contacted onto the inner surface of the cylindrically-shaped container sidewall 14A. The cathode comprises a cathode active material that is contacted to a rod-shaped cathode current collector 24. Fluorinated carbon (CFₓ) is a preferred cathode active material. In addition to fluorinated carbon (CFₓ), other suitable cathode active materials include silver vanadium oxide (SVO), copper silver vanadium oxide, copper vanadium oxide, manganese dioxide, titanium disulfide, copper oxide, copper sulfide, iron sulfide, iron disulfide, lithium cobalt oxide, and mixtures thereof.

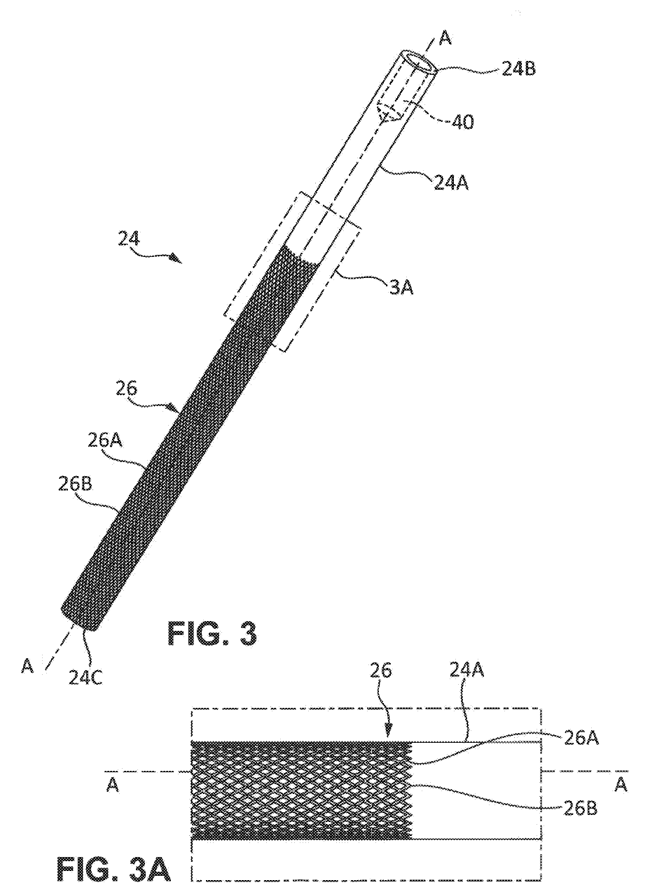

In one exemplary embodiment shown in FIGS. 3 and 3A, the cathode current collector 24 is a rod-shaped member having an outer surface in the shape of a cylinder aligned axially along the longitudinal axis A-A with an axial length extending from a proximal current collector portion 24A having a proximal end 24B to a distal current collector end 24C. The proximal portion 24A of the current collector 24 has a relatively smooth cylindrically-shaped outer surface. However, beginning distal the relatively smooth proximal portion 24A, a knurled surface 26 as a pattern of crisscrossing helical grooves 26A and 26B extends to the distal end 24C thereof.

As viewed from a perspective looking straight down at the proximal end 24B of the current collector 24, the crisscrossing pattern of helical grooves comprises a clock-wise extending helical groove 26A that winds as a three-dimensional narrow channel or depression turning around the longitudinal axis A-A of the rod-shaped member at a constant distance while moving parallel to the axis, and a counter-clockwise extending helical groove 26B that winds as a three-dimensional narrow channel or depression turning around the longitudinal axis A-A of the rod-shaped member at a constant distance moving parallel to the axis as it intersects the clock-wise extending helical groove 26A. The knurled surface 26 extends substantially to the distal end 24C of the current collector 24. The depth of the crisscrossing helical grooves 26A and 26B into the current collector 24 does not meet the longitudinal axis A-A. Preferably, the current collector 24 is devoid of any feature extending radially outwardly beyond its cylindrically-shaped outer surface.

In an alternate embodiment, the rod-shaped member has only one of the helical grooves. The one helical grooves can be either the clock-wise extending helical groove 26A or the counter-clockwise extending helical groove 26B.

Suitable materials for the current collector 24 include titanium, tantalum, platinum, gold, aluminum, cobalt nickel alloys, highly alloyed ferritic stainless steel containing molybdenum and chromium, and nickel-, chromium- and molybdenum-containing alloys, the former being preferred. For greater detail regarding a rod-shaped current collector 24 that is useful with the present electrical power source 10, reference is made to U.S. Patent No. 12,567,656 to Voss et al. The ‘656 patent is assigned to the assignee of the present invention and incorporated herein by reference.

The cathode 20 is then assembled by contacting a cathode active material, for example, fluorinated carbon CFₓ, to the current collector 24. The cathode active material as a unitary body is supported in a surrounding and contact relationship with the current collector 24 so that the active material fills in and resides in the groove 26A and 26B. That way, the cathode 20 has a substantially circular shape in cross-section extending along the current collector 24.

The cathode 20 comprising the cathode active material contacted to the current collector 24 is then housed in the separator envelope 22. Illustrative separator materials include non-woven glass, polypropylene, polyethylene, microporous materials, glass fiber materials, ceramics, the polytetrafluorethylene membrane commercially available under the designations ZITEX (Chemplast Inc.), the polypropylene membrane commercially available under the designation CELGARD (Celanese Plastic Company Inc.) and DEXIGLAS (C. H. Dexter, Div., Dexter Corp.). Other separator materials that are useful with the electrical power source 10 include woven fabrics comprising halogenated polymeric fibers, as described in U.S. Pat. No. 5,415,959 to Pyszczek et al., which is assigned to the assignee of the present invention and incorporated herein by reference. Examples of halogenated polymeric materials include, but are not limited to, polyethylene tetrafluoroethylene, which is commercially available under the name Tefzel, a trademark of the Du Pont Company, polyethylenechlorotrifluoroethylene which is commercially available under the name Halar, a trademark of the Allied Chemical Company, and polyvinylidene fluoride.

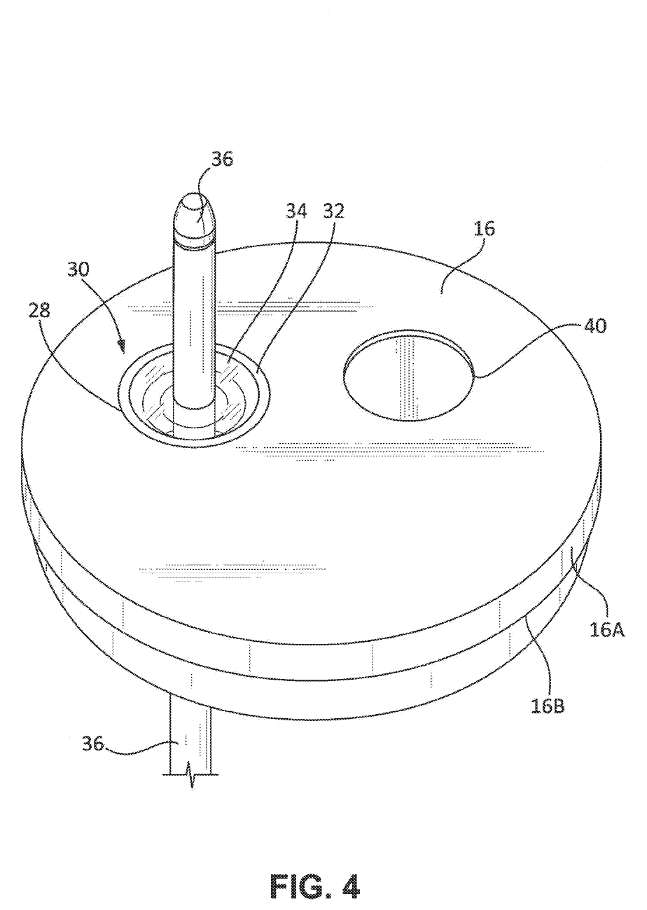

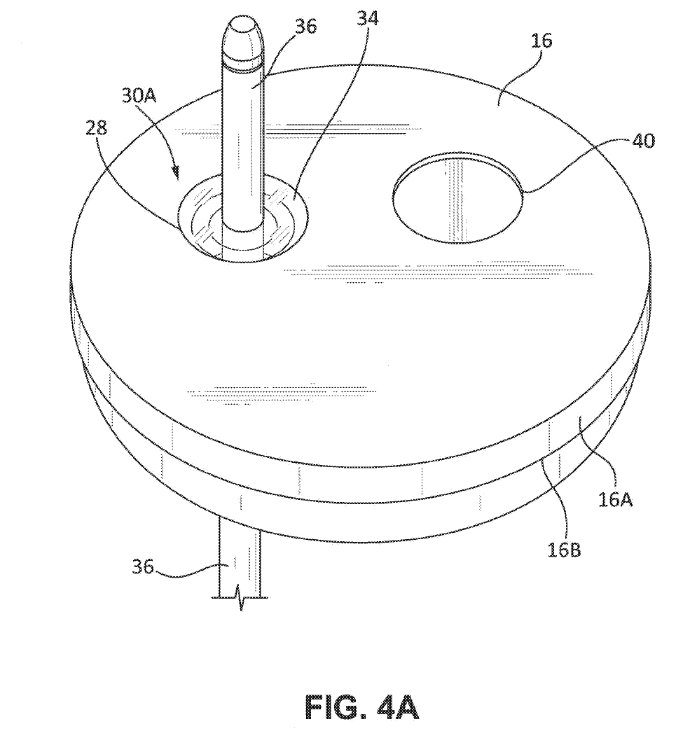

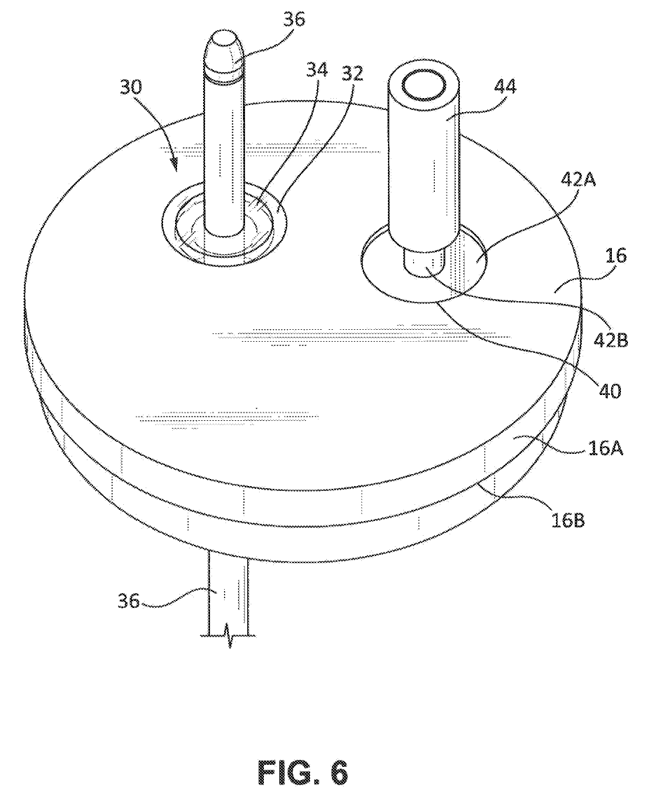

As particularly shown in FIGS. 4-6, the casing lid 16 is a plate-shaped member having a circular shape with a perimeter edge 16A which is sized and shaped to fit into the open end of the container 14. The casing lid 16 further has a GTMS opening 28 that is sized to receive a glass-to-metal seal (GTMS) 30. The GTMS 30 closing the GTMS opening 28 comprises a ferrule 32 supporting an insulating sealing glass or insulating ceramic 34 that seals between an inner surface of the ferrule and a terminal pin 36. The ferrule 32 is welded to the casing lid 16 to hermetically close the GTMS opening 28. The sealing glass 24 is of a corrosion resistant type having up to about 50% by weight silicon such as CABAL 12, TA 23, FUSITE 425 or FUSITE 435. The terminal pin 36 is of molybdenum, aluminum, nickel alloy, or stainless steel, the former being preferred.

FIG. 4A illustrates an alternate embodiment of a GTMS 30A for the casing lid 16. In this embodiment, the GTMS 30A does not have a ferrule. Instead, the insulator glass 34 seals directly to the inner surface of the casing lid 16 in the GTMS opening 28 and to the terminal pin 36.

As shown in FIGS. 1 and 2, a polymeric insulator disc 38 is supported on a device side extending portion of the terminal pin 36, seated against the ferrule 32. In this position, the outer surrounding edge of the disc 38 is sized and shaped to meet the inner surface of the cylindrically-shaped sidewall 14A comprising the casing tube 14. The insulator disc 38 is of a fluoro-polymer, such as ethylene tetrafluoroethylene (ETFE), and helps prevent attack of the insulator glass 30 by the electrolyte.

The device side of the terminal pin 36 is then slip-fit into a co-axial counter bore 40 in the proximal portion 24A of the rod-shaped cathode current collector 24 and resistance welded thereto. This connects the GTMS 30 supported in the lid opening 28 to the cathode 20. Preferably, the portion of the current collector 24 and terminal pin 36 between the upper surface of the cathode 20 and the insulator disc 38 remains uncovered by cathode active material.

This assembly comprising the cathode 20 housed inside the separator envelope 22 with the cathode current collector 24 connected to the terminal pin 36 of the GTMS 30 supported by the casing lid 16 is then moved into the open-ended casing container 14 to thereby position the cathode 20 in a facing relationship with the anode 18 comprising lithium contacted to the inner surface of the cylindrically-shaped container sidewall 14A. The electrode assembly is now housed inside the container 14. In one exemplary embodiment, the perimeter edge 16A of the casing lid 16 comprises a step 16B. A lower portion of the casing lid 16 below the step 16B is positioned within an interior perimeter formed by the annular rim 14B of the open-ended container 14. Preferably, the casing lid 16 is joined to the container 14 by welding around the junction between the lid step 16B and the annular rim 14B of the cylindrically-shaped container sidewall 14A. Suitable welding techniques include laser welding, resistance welding, arc welding, and magnetic pulse welding.

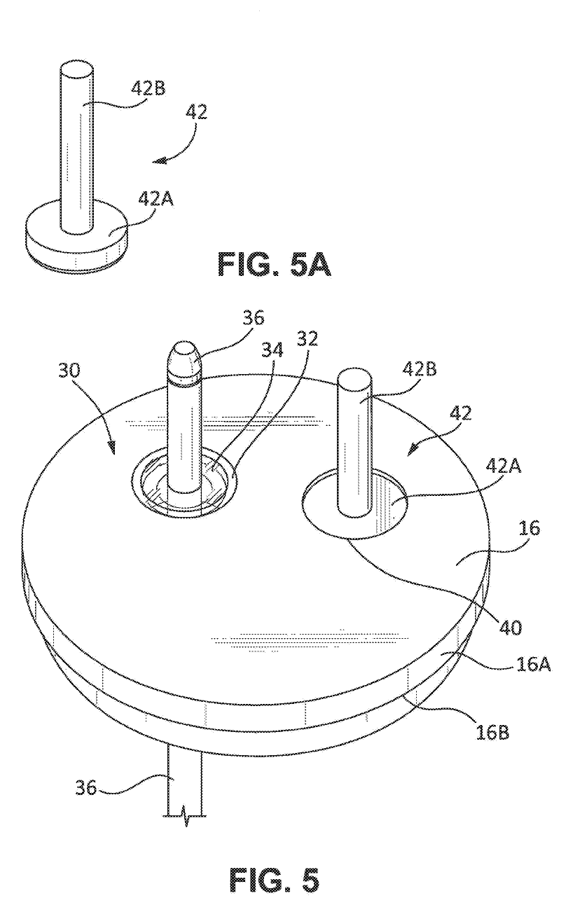

After the open-ended container 14 is closed by the casing lid 16, an electrolyte (not shown) is filled into the casing 12 through a fill port or fill opening 40 provided in the casing lid 16. In its fully assembled condition shown in FIG. 5, a fill port closure assembly 42 according to the present invention is then sealed in the electrolyte fill port 40 to hermetically close the casing 12. The fill port closure assembly 42 comprises a fill port closure plate 42A having a circular shape that is sized to fit into the fill port 40. Preferably, the fill port closure plate 42A has a planar upper surface and is joined to the casing lid 16 by welding, for example, laser welding, resistance welding, arc welding, and magnetic pulse welding to hermetically seal the container 14. The fill port closure assembly 42 further comprises an upstanding termination pin 42B that is either connected to the planar upper surface of the closure plate 42A, preferably by welding, or is machined as a unitary member with the fill port closure plate 42A.

An exemplary termination pin 42B has a length that ranges from about 0.25 inches to about 0.75 inches and a diameter that ranges from about 0.002 inches to about 0.005 inches. However, these dimensions are exemplary as an end user may desire a termination pin 42B with a different length and different diameter, all of which are within the scope of the present invention.

A fill port closure system that is useful with the present electrical power source 10 is described in U.S. Patent No. 10,446,825 to Voss et al. and comprises an inner sealing ball (not shown) and the outer closure plate 42A. The inner sealing ball is first welded into the fill port, and its function is to minimize, if not completely eliminate, out-gassing by-products that can be generated from the electrolyte during the welding process. If present, out-gassing by-products can adversely affect the integrity of the hermetic seal between the closure plate 42A and the casing lid 16. The ‘825 patent is assigned to the assignee of the present invention and incorporated herein by reference.

The significance of the fill port closure assembly 42 is that it serves as both a structure to close the fill port 40 and as a pin termination for an end user to connect to the electrical power source. As electrical power sources become smaller and smaller, miniature-sized power source designs, for example, those having a total volume that is not greater than 0.5 cc are being adapted to a wide variety of applications. To enable such advancements in miniature power source technology, the casing lid 16 has a diameter that ranges from about 0.45 inches to about 0.55 inches with a diameter of about 0.5 inches being preferred. In such miniature casing lids, it is difficult to find any extra space on the lid 16 for a negative polarity termination pin that an end user can connect to. That is in addition to the positive polarity terminal pin 36 of the GTMS 30. In that respect, the present fill port closure assembly 42 combines the fill port closure plate 42A and the termination pin 42B in a unitary construction that enables increased energy density, particularly in a miniature-sized electrical power source while maintaining pin termination options for the end user.

That way, the casing 12 comprising the open-ended container 14 closed by the lid 16 with the electrolyte fill port 40 in the lid in turn closed by the fill port closure assembly 42 serves as the negative terminal and the terminal pin 36 of the glass-to-metal seal (GTMS) 30 connected to the rod-shaped current collector serves as the positive terminal for the miniature electrical power source 10. If desired, the termination pin 42B can be gold plated or nickel plated, or a solder sleeve 44 can be welded to the pin to enable a solder connection to the negative terminal for the electrical power source 10.

Referring back to FIGS. 1 and 2, if the electrical power source 10 is an exemplary electrochemical cell constructed in what is generally referred to as a case-negative design, the anode 18 is electrically connected to the container 14 and the cathode 20 is electrically connected to the terminal pin 36 of the GTMS 30 via the rod-shaped cathode current collector 24. Alternatively, a case positive cell design may be constructed by reversing these connections. In other words, in a case-positive design the terminal pin 24 of the GTMS 30 is connected to the anode via the current collector 24 and the cathode is connected to the container 14. In that respect, the specific geometry and chemistry of the electrical power source 10 can be of a wide variety that meets the requirements of a specific primary or secondary cell application.

In greater detail, in an embodiment where the electrical power source 10 is a primary electrochemical cell, the anode 18 comprises a lithium or its alloys, for example, Li—Si, Li—Al, Li—B and Li—Si—B. The form of the anode may vary, but preferably it is of a thin sheet or foil pressed onto the inner surface of the sidewall 14A comprising the open-ended container 14.

The cathode 20 is of electrically conductive material, preferably a solid material. As previously described, while fluorinated carbon (CFₓ) is a preferred cathode active material, other suitable cathode active materials include silver vanadium oxide (SVO), copper silver vanadium oxide, copper vanadium oxide, manganese dioxide, titanium disulfide, copper oxide, copper sulfide, iron sulfide, iron disulfide, lithium cobalt oxide, and mixtures thereof.

Before being contacted to the current collector 24, however, the cathode active material is typically mixed with a binder material and a solvent. Binders such as, but not limited to, a powdered fluoro-polymer, more preferably powdered polytetrafluoroethylene or powdered poly vinylidene fluoride and solvents, such as but not limited to, trimethyl phosphate (TMP), dimethylformamide (DMF), dimethylacetamide (DMAc), tetramethyl urea (TMU), dimethyl sulfoxide (DMSO), or n-methyl-2-pyrrolidone (NMP) may be used. The binder is preferably present at about 1 to about 5 weight percent of the cathode mixture.

Further, up to about 10 weight percent of a conductive additive is preferably added to the cathode active mixture to improve conductivity. Suitable materials for this purpose include acetylene black, carbon black and/or graphite or a metallic powder such as powdered nickel, powdered aluminum, powdered titanium and powdered stainless steel. The preferred cathode active mixture for a primary electrochemical cell 10 thus includes a powdered fluoro-polymer binder present at about 3 weight percent, a conductive additive present at about 3 weight percent, and about 94 weight percent of the cathode active material.

When the electrical power source 10 is of a primary chemistry, the cell includes a nonaqueous, ionically conductive electrolyte having an inorganic, ionically conductive salt dissolved in a nonaqueous solvent and, more preferably, a lithium salt dissolved in a mixture of a low viscosity solvent and a high permittivity solvent. The salt serves as the vehicle for migration of the anode ions to intercalate or react with the cathode active material. Suitable salts include LiPF₆, LiBF₄, LiAsF₆, LiSbF₆, LiClO₄, LiO₂, LiAlCl₄, LiGaCl₄, LiC(SO₂CF₃)₃, LiN (SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof. Suitable salt concentrations typically range between about 0.8 to 1.5 molar.

Suitable low viscosity solvents include esters, linear and cyclic ethers and dialkyl carbonates such as tetrahydrofuran (THE), methyl acetate (MA), diglyme, trigylme, tetragylme, dimethyl carbonate (DMC), 1,2-dimethoxyethane (DME), 1,2-diethoxyethane (DEE), 1-ethoxy,2-methoxyethane (EME), ethyl methyl carbonate, methyl propyl carbonate, ethyl propyl carbonate, diethyl carbonate, dipropyl carbonate, and mixtures thereof. High permittivity solvents include cyclic carbonates, cyclic esters and cyclic amides such as propylene carbonate (PC), ethylene carbonate (EC), butylene carbonate, acetonitrile, dimethyl sulfoxide, dimethyl, formamide, dimethyl acetamide, γ-valerolactone, γ-butyrolactone (GBL), N-methyl-pyrrolidinone (NMP), and mixtures thereof. The preferred electrolyte for the electrochemical cell 10 of a lithium primary chemistry has 0.8M to 1.5M LiAsF₆ or LiPF₆ dissolved in a 50:50 mixture, by volume, of propylene carbonate (PC) as the preferred high permittivity solvent and 1,2-dimethoxyethane (DME) as the preferred low viscosity solvent.

In a secondary electrochemical system, the anode 18 comprises a material capable of intercalating and de-intercalating lithium. A carbonaceous anode material comprising any of the various forms of carbon (e.g., coke, graphite, acetylene black, carbon black, glassy carbon, etc.), which are capable of reversibly retaining lithium is preferred. Graphite is particularly preferred due to its relatively high lithium-retention capacity. Regardless the form of the carbon, fibers of the carbonaceous material are particularly advantageous because they have excellent mechanical properties that permit them to be fabricated into rigid electrodes capable of withstanding degradation during repeated charge/discharge cycling.

The cathode 20 of a secondary electrochemical cell 10 preferably comprises a lithiated material that is stable in air and readily handled. Examples of such air-stable lithiated cathode materials include oxides, sulfides, selenides, and tellurides of such metals as vanadium, titanium, chromium, copper, molybdenum, niobium, iron, nickel, cobalt and manganese. The more preferred oxides include LiNiO₂, LiMn₂O₄, LiCoO₂, LiCo_{0.92}Sn_{0.08}O₂, LiCo₁₋ₓNiₓO₂ (lithium cobalt nickel oxide), LiFePO₄, LiNiₓMn_{y}Co_{1-x-y}O₂ (lithium nickel manganese cobalt oxide), LiNiₓCo_{y}Al_{1-x-y}O₂ (lithium nickel cobalt aluminum oxide), Li₄Ti₅O₁₂, lithiated silver vanadium oxide, lithiated copper vanadium oxide, lithiated copper silver vanadium oxide (LiₓCu_{w}Ag_{y}V₂O_{z} with 0.5≤x≤4.0, 0.01≤w≤1.0, 0.01≤y≤1.0 and 5.01≤z≤6.5). Preferred sulfides include lithiated copper sulfide, lithiated iron sulfide, lithiated iron disulfide and lithiated titanium disulfide.

The lithiated active material is preferably mixed with a solvent, such as but not limited to, trimethyl phosphate (TMP), dimethylformamide (DMF), dimethylacetamide (DMAc), tetramethyl urea (TMU), dimethyl sulfoxide (DMSO), or n-methyl-2-pyrrolidone (NMP), and up to about 10 weight percent of a conductive additive selected from acetylene black, carbon black, graphite, and powdered metals of nickel, aluminum, titanium and stainless steel. The cathode further comprises a fluoro-resin binder, preferably in a powder form, such as PTFE, PVDF, ETFE, polyamides and polyimides, and mixtures thereof. The binder is present at about 1 weight percent to about 5 weight percent of the cathode mixture. Thus, the preferred cathode active mixture for a secondary electrochemical cell 10 includes a powdered fluoro-polymer binder present at about 3 weight percent, a conductive diluent present at about 3 weight percent, and about 94 weight percent of the cathode material.

Before being contacted to the current collector 24, however, the cathode active material is mixed with a binder material and a solvent. Binders such as, but not limited to, a powdered fluoro-polymer, more preferably powdered polytetrafluoroethylene or powdered polyvinylidene fluoride and solvents, such as, but not limited to, trimethyl phosphate (TMP), dimethyl formamide (DMF), dimethylacetamide (DMAc), tetramethyl urea (TMU), dimethyl sulfoxide (DMSO), or n-methyl-2-pyrrolidone (NMP) may be used. The binder is preferably present at about 1 to about 5 weight percent of the cathode mixture.

Secondary electrochemical systems are typically comprised of non-aqueous electrolytes comprising an inorganic salt dissolved in a non-aqueous solvent and more preferably one of the above-described lithium salts dissolved in a quaternary mixture of organic carbonate solvents comprising dialkyl (non-cyclic) carbonates selected from dimethyl carbonate (DMC), diethyl carbonate (DEC), dipropyl carbonate (DPC), ethyl methyl carbonate (EMC), methyl propyl carbonate (MPC), and ethyl propyl carbonate (EPC), and mixtures thereof, and at least one cyclic carbonate selected from propylene carbonate (PC), ethylene carbonate (EC), butylene carbonate (BC), and vinylene carbonate (VC), and mixtures thereof. Organic carbonates are generally used in the electrolyte solvent system for such battery chemistries because they exhibit high oxidative stability toward cathode materials and good kinetic stability toward anode materials.

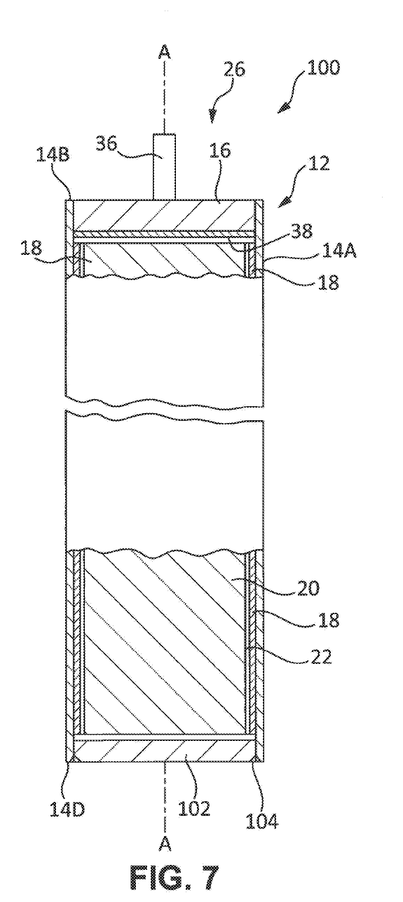

Turning now to FIG. 7, this drawing is a partial cross-sectional view of another embodiment of an electrical power source 100 according to the present invention. Power source 100 has structural characteristics that are similar to those of the power source 10 shown in FIGS. 1-3, 3A, 4, 4A, 5 and 6 described above except that the cylindrically-shaped sidewall 14A does not extend to a deep-drawn bottom wall 14C. Instead, the cylindrically-shaped sidewall 14A is closed at its distal open end by a lower closure plate 102. The lower closure plate 102 is preferably connected to a distal circular edge or annular rim 14D by an annular weld 104.

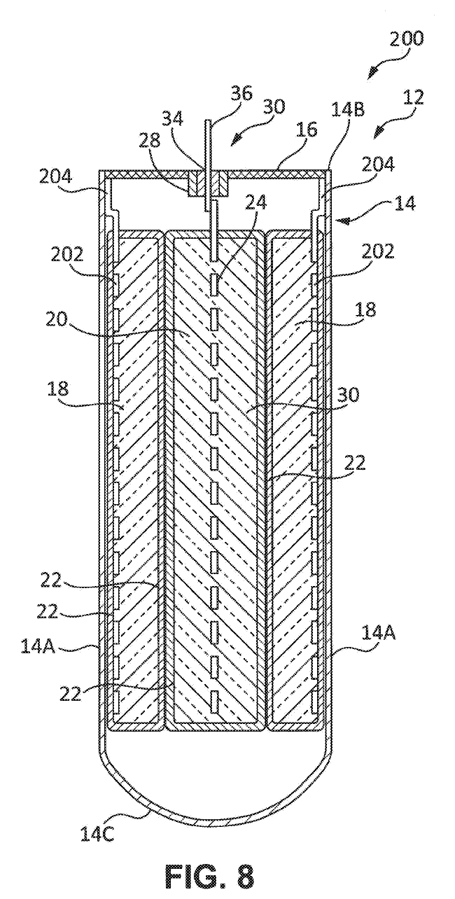

Referring now to FIG. 8, this drawing is a cross-sectional view of another embodiment of an electrical power source 200 according to the present invention. Power source 200 has structural characteristics that are similar to those of the power source 10 shown in FIGS. 1-3, 3A, 4, 4A, 5 and 6 described above except that the at least one sheet of lithium comprising the anode 18 is not press-contacted to the inner surface of the cylindrically-shaped sidewall 14A. Instead, the lithium sheet 18 is contacted to an anode current collector 202, and the current collector is connected to the inner surface of the cylindrically-shaped sidewall 14A for the container 14. Preferably, the anode current collector 202 is connected to the container sidewall at welds 204.

Thus, as electrical power sources are becoming smaller and smaller, the present electrolyte fill port closure systems comprising the fill port closure plate/negative polarity termination pin designs reduce the space needed for these features. This enables increased energy density while maintaining pin termination options for the end user. Improved pin position tolerance is another benefit because the negative polarity termination pin is integrated into the casing lid rather than welded to the lid spaced from the fill port. Further, the open-ended container can be deep drawn and not machined, saving costs.

It is appreciated that various modifications to the inventive concepts described herein may be apparent to those of ordinary skill in the art without departing from the spirit and scope of the present invention as defined by the appended claims.

What is claimed is:

1. An electrical power source, comprising:
a) a casing, comprising:
i) a container having an open end;
ii) a casing lid closing the open end of the container, wherein the casing lid has a GTMS opening spaced from an electrolyte fill port;
iii) a glass-to-metal seal (GTMS) connected to the casing lid in the GTMS opening, wherein the GTMS electrically isolates a terminal pin from the casing lid closing the container; and
iv) a fill port closure plate closing the electrolyte fill port;
b) an electrode assembly housed inside the casing, the electrode assembly comprising an anode and a cathode prevented from direct physical contact with each other by an intermediate separator; and
c) an electrolyte in the casing contacting the electrode assembly,
d) wherein one of the anode and the cathode is connected to the terminal pin of the GTMS serving as one terminal for the electrical power source, and the other of the anode and the cathode is connected to the casing comprising the container closed by the casing lid serving as the other terminal for the electrical power source.

2. The electrical power source of claim 1, wherein an upstanding termination pin is connected to the fill port closure plate.

3. The electrical power source of claim 1, wherein a weld connects the upstanding termination pin to the fill port closure plate.

4. The electrical power source of claim 1, wherein the upstanding termination pin connected to the fill port closure plate is a machined unitary assembly.

5. The electrical power source of claim 1, wherein the casing lid has a diameter that ranges from about 0.45 inches to about 0.55 inches.

6. The electrical power source of claim 1, wherein the GTMS opening and the electrolyte fill port in the casing lid each have a diameter that ranges from about 0.045 inches to about 0.06 inches.

7. The electrical power source of claim 1, wherein the anode is comprised of at least one sheet of lithium that is directly contacted to an inner surface of the casing without an anode current collector.

8. The electrical power source of claim 1, wherein the anode is comprised of at least one sheet of lithium that is contacted to an anode current collector, and the anode current collector is connected to an inner surface of the casing.

9. The electrical power source of claim 1, wherein the casing container is a deep-drawn container comprised of a cylindrically-shaped sidewall that meets a bottom wall at a rounded annular corner.

10. The electrical power source of claim 1, wherein the casing container is comprised of a cylindrically-shaped sidewall that is connected to a bottom plate.

11. The electrical power source of claim 1, wherein the cathode is comprised of a cathode active material that is contacted to a cathode current collector, and wherein the cathode current collector is connected to the terminal pin of the GTMS.

12. The electrical power source of claim 11, wherein the cathode active material is pressed into intimate contact with a rod-shaped cathode current collector having at least one helical groove, and the cathode current collector is connected to the terminal pin of the GTMS.

13. The electrical power source of claim 1, as a primary electrochemical cell comprising a lithium anode and a cathode comprising a cathode active material selected from fluorinated carbon (CFₓ), silver vanadium oxide (SVO), copper silver vanadium oxide, copper vanadium oxide, manganese dioxide, titanium disulfide, copper oxide, copper sulfide, iron sulfide, iron disulfide, lithium cobalt oxide, and mixtures thereof.

14. An electrical power source having a total volume that is about 0.5 cc, the power source comprising:
a) a casing, comprising:
i) a cylindrically-shaped container having an open end;
ii) a casing lid closing the open end of the container, wherein the casing lid has a diameter that ranges from about 0.45 inches to about 0.55 inches and comprises a GTMS opening spaced from an electrolyte fill port;
iii) a glass-to-metal seal (GTMS) connected to the casing lid in the GTMS opening, wherein the GTMS electrically isolates a terminal pin from the casing lid closing the container; and
iv) a fill port closure plate welded to the lid in the electrolyte fill port; and
b) an electrode assembly housed inside the casing, the electrode assembly comprising:
i) an anode comprising lithium electrically connected to the casing;
ii) a cathode is comprised of a cathode active material contacting a cathode current collector, wherein the cathode current collector is connected to the terminal pin of the GTMS; and
iii) a separator positioned between the anode and the cathode; and
c) an electrolyte in the casing contacting the electrode assembly,
d) wherein the anode is connected to the casing comprising the container closed by the casing lid serving as the negative terminal for the electrical power source, and wherein the cathode is connected to the terminal pin of the GTMS serving as a positive terminal for the electrical power source.

15. The electrical power source of claim 14, wherein an upstanding termination pin is connected to the fill port closure plate so that the termination pin serves as a negative polarity termination for the power source.

16. The electrical power source of claim 14, wherein the anode is comprised of at least one sheet of lithium that is directly contacted to an inner surface of the casing without an anode current collector, or the anode is comprised of at least one sheet of lithium that is contacted to an anode current collector, and the anode current collector is connected to an inner surface of the casing.

17. The electrical power source of claim 14, wherein a weld connects the upstanding termination pin to the fill port closure plate, or the upstanding termination pin connected to the fill port closure plate is a machined unitary assembly.

18. The electrical power source of claim 14, wherein the casing lid has a diameter that ranges from about 0.45 inches to about 0.55 inches, and wherein the GTMS opening and the electrolyte fill port in the casing lid each have a diameter that ranges from about 0.045 inches to about 0.06 inches.
